(19) United States
(12) Patent Application Publication
(10) Pub. No.: US 2022/0404602 A1
(43) Pub. Date: Dec. 22, 2022

(54) SYSTEMS, METHODS, AND APPARATUSES FOR IMMERSION MEDIA APPLICATION AND LENS CLEANING

(71) Applicant: FEI DEUTSCHLAND GMBH, Dreieich (DE)

(72) Inventors: Xaver VOEGELE, Planegg (DE); Andreas ACHTERMANN, Planegg (DE); Thierry BOTTARO, Planegg (DE); Rainer DAUM, Planegg (DE)

(21) Appl. No.: 17/619,902

(22) PCT Filed: Dec. 18, 2020
(86) PCT No.: PCT/IB2020/062232

§ 371 Date: Dec. 16, 2021

Related U.S. Application Data
(60) Provisional application No. 62/951,429, filed on Dec. 20, 2019.

(51) Int. Cl. G02B 21/33; G02B 27/00

(52) U.S. Cl. CPC G02B 21/33; G02B 27/0006

(57) ABSTRACT

An imaging system configured for automatic application and/or removal of immersion media can include (i) a sample stage, (ii) an imaging assembly disposed on a first side of the sample stage and having an immersion objective configured to selectively align with an optical axis of the imaging system, and (iii) an applicator positioned to selectively interact with a lens surface of the immersion objective to deposit or remove immersion media.

### BACKGROUND

### Technical Field

This disclosure generally relates to microscopy. More specifically, the present disclosure relates to systems, methods, and apparatuses for the application and cleaning of immersion media on objective lenses.

### Related Technology

Microscopy is concerned with observing small, often microscopic, objects. Traditional microscopes incorporate a system of lenses to magnify, and thereby allow viewing of, small objects. In an optical light microscope, a system of lenses directs a magnified image of the small object to an eyepiece of the microscope while in a digital microscope, the image is focused on an image sensor. In either case, light microscopes are commonly used to capture images of microscopic objects. At lower magnification, a wide field of view can be used (at lower resolution) to quickly navigate within or between samples, and upon identifying a point of interest, a higher resolution objective lens can be moved into the optical axis and allow the point of interest to be viewed or imaged in greater detail. Objective lenses with a high numerical aperture, which offer high resolution, are limited by the refractive index of air unless an immersion media with a refractive index greater than air is placed between the sample and the objective lens. Accordingly, immersion media is commonly used in light microscopy applications to obtain high resolution sample images.

Immersion media can be applied to the objective lens manually, but with the advent of automated, high throughput imaging systems, the application of immersion media to the high-resolution objective lenses became a bottleneck in the productivity and efficiency of the system. The objectives in many automated imaging systems are difficult to quickly access and are often confined to a small space. Prior efforts to address the problem of automatedly applying immersion media to an objective lens are fraught with problems and limitations. For example, prior systems are often only able to effectively apply immersion media to a single objective lens due to the space constraints and dynamic movements of components within an automated imaging system. Additionally, prior systems include additional motors or actuators that are used to move and/or flip the immersion applicator into and out of operable configurations, adding to the mechanical and operational complexity of these systems. If additional or different immersion objectives are to be used in the automated imaging process, prior systems require a reconfiguration of the immersion media applicator and/or objective lenses within the system or, in some instances, require the addition of multiple applicators.

Prior systems additionally fail to provide an automated and effective way to clean immersion media from immersion objectives. Prolonged exposure to some immersion media (e.g., cedar tree oil) can negatively impact the longevity or functionality of the objective. Even for immersion media that are not caustic or whose properties remain relatively unchanged over time or with exposure to light, best practices for optimal performance of an imaging system include removal of immersion media from lenses promptly after use or between applications. Prior systems fail to address this additional problem in the art of automated imaging systems that utilize light microscopy methods.

Accordingly, there are a number of disadvantages and problems that can be addressed in the art of automated light microscopy, and there is an outstanding need for systems, methods, and apparatuses that can conveniently and automatedly apply immersion media to objective lenses in an automated system and/or that can automatedly clean or remove immersion media from objective lenses, particularly with automated light microscopes.

### BRIEF SUMMARY

Various embodiments disclosed herein are related to apparatuses, methods, and systems for immersion media application and lens cleaning.

A first aspect of the disclosed embodiments provides for an imaging system configured for automatic application and/or removal of immersion media. The imaging system includes (i) a sample stage, (ii) an imaging assembly disposed on a first side of the sample stage and having an immersion objective configured to selectively align with an optical axis of the imaging system, and (iii) an applicator positioned to selectively interact with a lens surface of the immersion objective to deposit or remove immersion media.

In one aspect, the applicator includes an immersion media nozzle. The immersion media nozzle can be configured to dispense immersion media without bubbles and can include a bubble sensor configured to detect a presence of a bubble at the immersion media nozzle or within the upstream line feeding immersion media to the immersion media nozzle. The applicator can additionally, or alternatively, include a liquid sensor for detecting a presence of immersion media at the immersion media nozzle. The liquid sensor can include an optical sensor, a multimeter for measuring resistance at the lens surface of the immersion objective, or a capacitor sensor.

In one aspect, the imaging system additionally includes a hose joining the applicator to an immersion media reservoir and can also include a pump associated with the hose that is configured to dispense immersion media from the immersion media reservoir through the applicator. For example, the pump can be configured to dispense a desired volume of immersion media based on an operating time and/or a number of operating cycles.

In one aspect, the applicator is disposed on the first side of the sample stage and can be integrated into and co-translational with the sample stage. Such a sample stage can be a motorized xy-stage that is configured to position the applicator adjacent to the lens surface of the immersion objective such that dispensing immersion media from the applicator causes immersion media to be deposited onto the lens surface of the immersion objective.

In one aspect, the imaging system is an inverted microscope with the imaging assembly being positioned below the sample stage and the first side of the sample stage being a bottom of the sample stage such that the applicator is disposed on the bottom of the sample stage directionally toward the immersion objective. Alternatively, the imaging system can be an upright microscope with the imaging assembly being positioned above the sample stage and the first side of the sample stage being a top of the sample stage such that the applicator is disposed on the top of the sample stage directionally toward the immersion objective.

In one aspect, the imaging system additionally includes a wipe configured to clean and/or remove immersion media from the lens surface of the immersion objective. The wipe can contain cleaning agent and can, in some instances, be the applicator. In such instances, the imaging system can additionally include a translocation element operably connected to the wipe and configured to selectively move the wipe. The selective movement of the wipe can be or include a linear or back and forth movement, a movement within a single plane, or a rotational movement. The translocation element can be, for example, a solenoid providing a vibration-like amplitude to the wipe or can be otherwise associated with a mechanism for moving the sample stage. Additionally, or alternatively, the imaging system includes a computing system configured to generate a map of the wipe, to track portions of the wipe previously used to clean the immersion objective, and to direct movement of the wipe on a subsequent cleaning operation to interact with the immersion objective at a clean or unused area of the wipe.

In one aspect, the applicator is a suction device configured to remove immersion media from the lens surface of the immersion objective. Such an applicator can be disposed at a stationary position within a housing of the imaging system. The imaging assembly can include a lens slide or turret onto which the immersion objective is mounted and that is selectively positionable under the applicator to receive immersion media from the applicator onto the lens surface of the immersion objective. Such exemplary imaging systems can additionally include a wipe (e.g., containing cleaning agent) configured to clean and/or remove immersion media from the lens surface of the immersion objective.

In one aspect, the applicator is a wipe, and the imaging system can additionally include a vibrating element operably connected to the wipe and configured to selectively vibrate the wipe. The lens slide or turret can be selectively positionable under the wipe to remove immersion media from the lens surface of the immersion objective.

In one aspect, the imaging system includes a second immersion objective, and the applicator is additionally configured to selectively interact with a respective lens surface of the second immersion objective.

The present disclosure additionally includes methods for automatically applying immersion media to an immersion objective. In one aspect, the method includes obtaining an imaging system as disclosed herein, positioning the sample stage relative to the immersion objective such that the applicator associated with the imaging system is adjacent to the lens surface of the immersion objective, and dispensing immersion media from the applicator onto the lens surface of the immersion objective.

In one aspect, methods for automatically applying immersion media to an immersion objective includes obtaining an imaging system as disclosed herein, positioning the immersion objective relative to the applicator such that the applicator is adjacent to the lens surface of the immersion objective, and dispensing immersion media from the applicator onto the lens surface of the immersion objective. In some aspects, the method act of dispensing immersion media can additionally include dispensing immersion media that does not contain bubbles.

The present disclosure additionally includes methods for automatically removing immersion media from a lens surface of an immersion objective. In one aspect, the method includes obtaining an imaging system disclosed herein that includes a wipe or suction device, positioning the sample stage relative to the immersion objective such that the applicator is adjacent to the lens surface of the immersion objective, and removing the immersion media from the lens surface of the immersion objective via the wipe or suction device.

Embodiments of the present disclosure additionally include kits for automatedly dispensing immersion media. In one aspect, the kit includes an immersion media reservoir configured to hold a volume of immersion media, an applicator, such as a nozzle, fluidically coupled to the immersion media reservoir by an immersion media hose, and a micropump operable to move immersion media from the immersion media reservoir, through the immersion media hose, and to the nozzle for dispensing.

In one aspect, the kit includes computer-executable instructions that when executed by one or more processors of a computer system cause the applicator to automatedly dispense immersion media. In one aspect the computer-executable instructions, when executed by the processor(s) of a computer system, cause a wipe or suction device to remove immersion media from the lens surface of an immersion objective, or otherwise clean the lens surface of the immersion objective, via the wipe or suction device.

In one aspect, the kit additionally includes one or more of a liquid sensor configured to detect the presence of immersion media at the nozzle, a nonreturn valve associated with the immersion media hose to prevent the pumped immersion media from retreating to the immersion media reservoir when not being pumped, a level indicator associated with the immersion media reservoir, and/or a waste reservoir and a waste level indicator associated with the waste reservoir.

In one aspect, the kit is operable to be retrofitted to an automated light microscope post manufacturing.

In one aspect, an exemplary kit includes a nozzle associated with an immersion media hose for fluidically coupling to an immersion media reservoir and a micropump operable to move immersion media from the immersion media reservoir, through the immersion media hose, and to the nozzle for dispensing at an immersion objective. Such an exemplary kit can include computer-executable instructions that when executed by one or more processors of a computer system cause the nozzle to automatedly dispense immersion media on one or more immersion media lenses at user-selected times and/or intervals. In one aspect, the kit additionally includes a wipe or suction device to remove immersion media from the lens surface of an immersion objective, or otherwise clean the lens surface of the immersion objective via the wipe or suction device. The computer-executable instructions can additionally, when executed by processor(s) of a computer system, cause the wipe or suction device to remove immersion media from (or otherwise clean) the lens surface of an immersion objective. In one aspect, the kit can additionally include a liquid sensor configured to detect the presence of immersion media at the nozzle and a nonreturn valve associated with the immersion media hose to prevent the pumped immersion media from retreating to the immersion media reservoir when not being pumped.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims or may be learned by the practice of the disclosure as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof, which are illustrated in the appended drawings. It is appreciated that these drawings depict only typical embodiments of the disclosure and are not therefore to be considered limiting of its scope. The disclosure will be described and explained with additional specificity and detail through the accompanying drawings in which:

FIG. 1A illustrates a typical upright microscope as known in the prior art;

FIG. 1B illustrates a typical inverted microscope as known in the prior art;

FIG. 2 illustrates an example embodiment of a system incorporating features disclosed or envisioned herein;

FIG. 3 illustrates a plan view of the longitudinal cross sectional of an exemplary imaging system, in accordance with embodiments of the present disclosure;

FIG. 4A illustrates a schematic of an exemplary immersion media applicator associated with an imaging system having objectives mounted on an objective lens slider, in accordance with embodiments of the present disclosure;

FIG. 4B illustrates a schematic of an exemplary immersion media applicator associated with an imaging system having objective lenses mounted on an objective lens turret, in accordance with embodiments of the present disclosure;

FIG. 5A illustrates a top perspective view of the interior portion of the stage housing and associated objective lens of an exemplary imaging system incorporating an immersion media applicator into the microscope stage, in accordance with embodiments of the present disclosure;

FIG. 5B is a top perspective view of an exemplary sample holder arm configured for mounting on the xy-stage of an imaging system, the sample holder arm incorporating an immersion media applicator on the side of the illustrated arm, in accordance with embodiments of the present disclosure;

FIG. 5C illustrates a schematic of an exemplary nozzle and immersion media sensor in accordance with embodiments of the present disclosure;

FIG. 6A is a schematic of an exemplary immersion media applicator associated with a stage assembly and is shown in a configuration where immersion media is applied from the nozzle integrated into the stage and onto a desired objective lens associated with an inverted microscope system, in accordance with embodiments of the present disclosure;

FIG. 6B is a schematic of the exemplary immersion media applicator of FIG. 6A and is shown in an imaging configuration with the applied immersion media disposed between the objective lens and bottom surface of the multiwell plate held by the stage assembly, in accordance with embodiments of the present disclosure;

FIG. 7 is a schematic of an exemplary immersion media applicator associated with a stage assembly and is shown in a configuration where immersion media can be applied from a nozzle integrated/associated with the stage and onto a desired objective lens of an upright microscope, in accordance with embodiments of the present disclosure;

FIG. 8 illustrates a schematic of an exemplary lens cleaning apparatus, in accordance with embodiments of the present disclosure;

FIG. 9 illustrates a schematic of another exemplary lens cleaning apparatus, in accordance with embodiments of the present disclosure; and

FIG. 10 illustrates a schematic of an exemplary immersion media applicator and lens cleaning apparatus, in accordance with embodiments of the present disclosure.

### DETAILED DESCRIPTION

Before describing various embodiments of the present disclosure in detail, it is to be understood that this disclosure is not limited to the parameters of the particularly exemplified systems, methods, apparatus, products, and/or processes, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, the terminology used herein is for the purpose of describing the embodiments and is not necessarily intended to limit the scope of the claimed invention.

Furthermore, it is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims.

### Overview of Imaging Systems and Methods

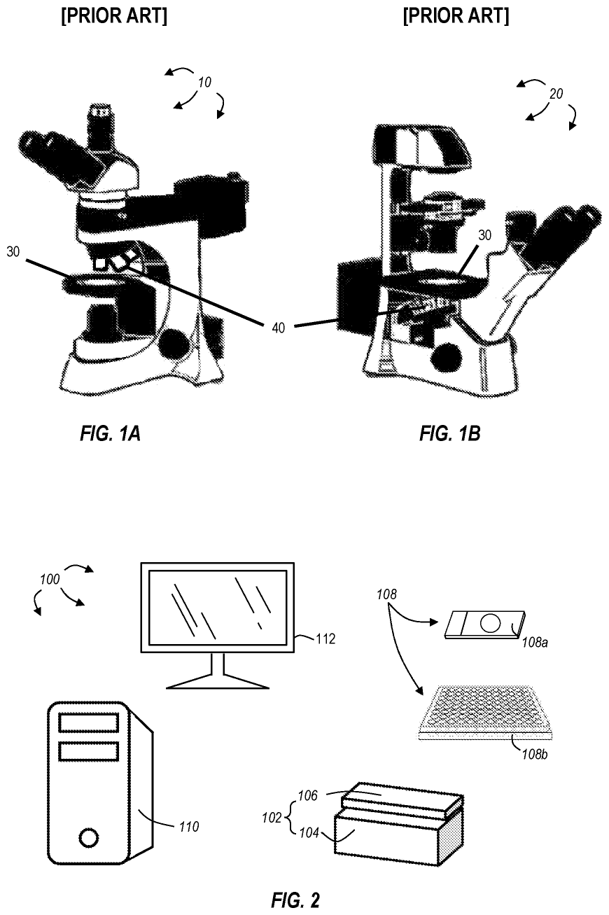

FIGS. 1A and 1B illustrate prior art embodiments of an upright light microscope 10 (FIG. 1A) and an inverted light microscope 20 (FIG. 1B). Each of the illustrated light microscopes 10, 20 include a sample stage 30 and objectives 40 aligned with the optical axis of the respective microscope 10, 20. Each light microscope 10, 20 is associated with a plurality of objectives organized on a turret that can be rotated to align a different objective with the optical axis of the microscope. Both light microscopes are capable of epi-illumination and transillumination imaging of a sample, but one main difference between the upright light microscope 10 of FIG. 1A and the inverted light microscope 20 of FIG. 1B is the position of the objective lenses relative to the sample stage. The upright light microscope 10 in FIG. 1A includes an objective turret disposed above the sample stage, while the respective objective turret of the inverted light microscope 20 in FIG. 1B is positioned below the sample stage. In a major way, this can affect the type of samples that are viewed with the high-resolution objective lenses with each type of microscope.

For example, when viewing samples with the immersion objectives of an upright or inverted light microscope, it is beneficial for the desired focal plane of the sample to be viewed directly through the immersion media without intervening air space and/or by minimizing the different types of materials the light passes through before being received within the optical train of the microscope. As such, samples within microwell plates are typically best viewed/imaged using an inverted light microscope, whereas a cross-sectional tissue samples on a glass slide with a coverslip is perhaps better viewed with an upright light microscope.

Regardless of the sample type or viewing angle, upright and inverted microscopes are joined by the common thread that use of immersion objectives with these platforms has traditionally required manual application of the immersion media to the objective. For example, when applying immersion media to an objective of an inverted light microscope (e.g., the inverted light microscope 20 of FIG. 1B), the user can manually lower the objective turret (or partially rotate the turret to gain access to the objective lens), apply the immersion media, and return the objective to the focal plane where the immersion media bridges the gap between the surface of the objective lens and the glass surface separating the immersion media from the sample. Similarly, when applying immersion media for high resolution imaging of a sample on an upright microscope, the turret can be partially rotated to gain access to the portion of the glass coverslip below the axially aligned high-resolution immersion objective (or other suitable imaging surface between the sample and objective lens) where the immersion media can be deposited. Rotating the immersion objective over the sample and into an axially aligned position will cause the deposited immersion media to form an immersion media layer between the glass coverslip and the objective lens.

As exemplified in the foregoing, manually applying immersion media to view a single sample is a time intensive process and is benefitted by open access to the objective turret. In an automated imaging system, each sample can be imaged at multiple, different levels of resolution, which may necessitate reiterated changes between a plurality of objective lenses during the imaging process. If, for example, such an imaging process called for two different immersion objectives to be used in series, current systems lack an efficient and effective solution for applying and/or maintaining a proper volume of immersion media on each immersion objective between rotations. Further, continued or over application of immersion media can cause the objective lenses to become gunky and/or may negatively impact the consistency and quality of acquired images. Current systems further lack the ability to automatedly remove and/or clean immersion media from objective lenses.

Embodiments of the present disclosure beneficially provide systems and methods for automatedly applying and cleaning immersion media from objective lenses and have particular benefits when applied to automated imaging systems. For example, in some embodiments disclosed herein, an immersion media applicator is integrated within the sample stage of an automated system Immersion media can be applied to the desired objective by moving the sample stage over the desired immersion objective such that the outlet nozzle of the applicator is oriented above the lens surface where it can discharge a discrete volume of immersion media thereon. When integrated into the sample stage itself, little—if any—additional space is needed within the stage assembly area to implement the applicator. The reservoir of immersion media associated with the nozzle can be housed outside of the sample stage assembly area and drawn thereto via a flexible hose. In this way, embodiments of the present disclosure beneficially allow for the retrofitting of most any automated imaging system without impacting the function or mobility of existing components and can beneficially reduce the mechanical complexity (and associated cost) associated with prior systems that require additional motors or flip mounts to move a nozzle on top of the objective lens. Additionally, embodiments of the present disclosure beneficially allow for the application of immersion media to any objective within an automated imaging system that can be used for imaging samples held by the sample stage, regardless of whether the objectives are held by a turret or objective lens slider.

In some embodiments of the present disclosure, the immersion media applicator consists of a static hose and nozzle extending into the stage assembly area of an automated imaging system. Instead of positioning the sample stage over a stationary objective lens for immersion media application, the objective lenses are moved to the applicator (e.g., via an objective lens slider) where immersion media can be applied directly to the desired objective. Upon automatedly receiving the immersion media, the objective lens can be repositioned at the sample for high resolution imaging. Additional features and benefits of the disclosed systems are provided herein with reference to embodiments disclosed in the accompanying drawings.

For example, FIG. 2 is a general schematic of an exemplary system 100 incorporating features disclosed or envisioned herein. At the heart of the system 100 is an imaging system 102 in which samples, such as biological cells, are imaged and analyzed. The exemplary imaging system 102 includes, but is not limited to, a light microscope assembly 104 and a computing device 110. Within the light microscope assembly 104 is an image sensor (e.g., any CCD or CMOS sensor array or chip or as otherwise known in the art) configured to capture image data from a sample positioned within the field of view of the image sensor.

As shown in FIG. 2, a stage housing 106 can be mounted on or otherwise be associated with the light microscope assembly 104 to facilitate positioning of the sample 108 to be optically aligned with the optical train of the light microscope assembly 104. The sample can be included within or mounted on any sample receiving apparatus, including, for example, a microscope slide 108a, a multi-well plate (e.g., a 96-well plate 108b shown in FIG. 2), or similar. Accordingly, the stage housing 106 can include one or more light sources to illuminate the sample 108, which can be, for example, a white light or a light of a defined wavelength. It should be appreciated that in some embodiments, the light sources are included within the microscope assembly 104. In embodiments where the light emitter includes a fluorophore, the light source can include a fluorophore excitation light source. For example, the stage housing 106 can include a light engine comprising multiple light emitting diodes (LEDs) or lasers configured to emit white light and/or an excitation wavelength for exciting fluorophores within the sample 108. Additionally, or alternatively, the stage housing 106 can include optical filters that filter the excitation and emission light, such as a multi-position dichroic filter wheel and/or a multi-position emission filter wheel.

As a general working example, a sample-containing multiwell plate can be positioned within the stage housing 106 such that a desired sample well is optically aligned with the optical train of the associated light microscope assembly 104, including a desired objective lens. The objective lens can be switched to a lower or higher resolution objective (e.g., by rotating an associated turret or repositioning the objective lenses via an objective lens slider) and the sample illuminated via a white light source.

As another example, a fluorophore excitation source can be automatically or manually directed to provide multiple bandwidths of light ranging from violet (e.g., 380 nm) to near infrared (e.g., at least 700 nm) and are designed to excite fluorophores, such as, for example, cyan fluorescent protein (CFP) and Far Red (i.e., near-IR) fluorophores. Example bandwidths with appropriate excitation filters (e.g., as selected via a computing device 110 driven excitation filter wheel) can include, but are not limited to, Violet (e.g., 380-410 nm LED & 386/23 nm excitation filter), Blue (e.g., 420-455 nm LED & 438/24 nm excitation filter), Cyan (e.g., 460-490 nm LED & 485/20 nm excitation filter), Green (e.g., 535-600 nm LED & 549/15 nm excitation filter), Green (e.g., 535-600 nm LED & 560/25 nm excitation filter), Red (e.g., 620-750 nm LED & 650/13 nm excitation filter), and Near-IR (e.g., 700 nm-IR LED & 740/13 nm excitation filter). The two Green/excitation filter combinations listed above can be provided optionally via, for example, a mechanical flipper, when desiring to improve the brightness of red and scarlet dyes. Of course, other LED bandwidths can also be used, replaced, or complemented with a laser emitting any of the desired excitation bandwidths and/or wavelengths.

Additionally, or alternatively, the stage housing 106 can include a stage assembly and positioning mechanism configured to retain and selectively move sample for viewing by the objective lens aligned with the remaining portions of the optical train within light microscope assembly 104. As it should be appreciated, the stage assembly can be configured to move within any of three-dimensions, as known in the art. For example, the stage assembly can be configured to move laterally (e.g., in an x, y-plane parallel to the surface of the associated objective lens) to position different portions of the sample within the field of view. The stage assembly can additionally, or alternatively, be configured to move in a z-direction (e.g., between parallel xy-planes that are each disposed at different distances from the surface of the objective lenses) using any mechanism known in the art, such as, for example, a stepper motor and screw/nut combination providing stepwise movements of the sample toward/away from the objective lenses.

The stage assembly can be moved to position the desired sample within the focal plane of the light microscope assembly 104 and upon capturing image data at the light microscope assembly 104, the data can be viewed, analyzed, and/or stored within an associated computing device 110. Embodiments disclosed or envisioned herein may comprise or utilize a special purpose or general-purpose computer including computer hardware, such as, for example, one or more processors, as discussed in greater detail below. Embodiments may also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer. A “network” is defined as one or more data links that enable the transport of electronic data between computer systems and/or modules and/or other electronic devices. When information is transferred or provided over a network or another communications connection (either hardwired, wireless, or a combination of hardwired and wireless) to a computer, the computer properly views the connection as a transmission medium. Transmission media can include a network and/or data links which can be used to carry data or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., an “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that embodiments may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, tablets, smart phones, routers, switches, and the like. Embodiments may be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. Program modules for one entity can be located and/or run in another entities data center or “in the cloud.”

With continued reference to the system 100 of FIG. 2, the computing device 110 can additionally be used as a controller for the system 100 as well as for performing, by itself or in conjunction with light microscope assembly 104, the number and resolution of images taken per sample, the imaging path taken, the objective lenses to be used for imaging aspects of the sample(s), the automated application of immersion media to objective lenses, and/or the automated cleaning of immersion media from objective lenses. The computing device can additionally be used to conduct image analysis and/or store images and data obtained by the light microscope assembly 104. The computing device 110 can comprise a general purpose or specialized computer or server or the like, as defined herein, or any other computerized device. The computing device 110 can communicate with light microscope assembly 104 directly or through a network, as is known in the art. In some embodiments, computing device 110 is incorporated into the light microscope assembly 104. In some embodiments, the computing device is incorporated within the light microscope assembly.

System 100 can also include a user display device 112 to display results and/or system configurations. Light microscope assembly 104 and/or computing device 110 can communicate, either directly or indirectly, with user display device 112 to program and/or control the automated imaging method, which can include, for example, the automated application of immersion media to an appropriate immersion objective prior to and/or during the imaging method.

In one embodiment, one or more of the method steps described herein are performed as a software application. However, embodiments are not limited to this and method steps can also be performed in firmware, hardware or a combination of firmware, hardware and/or software. Furthermore, the steps of the methods can exist wholly or in part on the light microscope assembly 104, computing device 110, and/or other computing devices.

An operating environment for the devices of the system may comprise or utilize a processing system having one or more microprocessors and system memory. In accordance with the practices of persons skilled in the art of computer programming, embodiments are described below with reference to acts and symbolic representations of operations or instructions that are performed by the processing system, unless indicated otherwise. Such acts and operations or instructions are referred to as being “computer-executed,” “CPU-executed,” or “processor-executed.”

Various embodiments disclosed herein are related to apparatuses, methods, and systems for immersion media application and lens cleaning. Such embodiments beneficially improve microscopy systems by enabling the automated application of immersion media to an objective lens before and/or during automated imaging runs. Such embodiments can additionally, or alternatively, provide an automated lens cleaning system that can beneficially remove immersion media and/or clean objective lenses at any point prior to, during, and/or following sample imaging where immersion media is used, thereby increasing the consistency and/or quality of images obtained by the associated imaging system and decreasing the likelihood of possible damage to the objective lens caused by extended or repeated exposure to immersion media when the affected objective lens is not in use. Various embodiments can also be easily incorporated into existing imaging systems (e.g., at the original equipment manufacturer and/or as a retrofit to already manufactured imaging systems) without substantially hindering the movement and/or operation of components within the system, and the beneficially small footprint of the disclosed immersion media applicators and disclosed lens cleaners—in addition to the position and operation of the same within imaging systems—enables an expanded utilization of objective lenses and imaging modalities.

Additionally, embodiments disclosed herein can increase the efficiency and ease by which immersion media is applied and cleaned from objective lenses housed within automated imaging systems that may be difficult or time consuming to access. As a result, embodiments disclosed herein provide researchers and other imaging system operators with additional flexibility when planning or implementing an automated (e.g., high throughput) image capture process. For example, immersion media applicators disclosed herein can be configured to apply immersion media to any number (e.g., some or all) of objective lenses easily and while maintaining or returning to a desired field of view with great precision and accuracy. Embodiments disclosed herein can also beneficially reduce focus drift as the immersion media is positioned within the same incubator/controlled environment as the objective lenses prior to its application.

Image capture events over an extended duration (e.g., multiple hours or days long) can also be implemented with less time spent maintaining the immersion media interface between the objective lens and the sample and can beneficially enable the application and/or cleaning of immersion media on multiple objective lenses throughout the extended duration image capture event with a reduced amount or duration of imaging interruptions.

### Exemplary Immersion Media Applicators and Systems

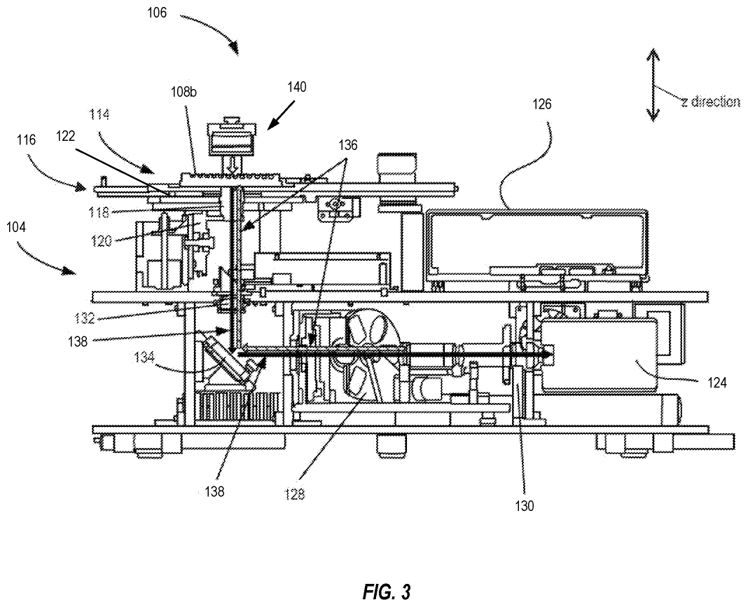

Referring now to FIG. 3, illustrated is an exemplary embodiment of the imaging system 102 generally disclosed in FIG. 2. The interior platform design of the exemplary system 102 is illustrated as a cross-sectional side view in FIG. 3. In general, imaging system 102 integrates components required to position a sample (e.g., a multiwell sample plate containing biological cells) for automated imaging.

Stage housing 106 includes a stage assembly 114 mounted in a manner so as to optically and mechanically cooperate with components that make up microscope assembly 104. Stage assembly 114 generally includes a stage 116 on which sample 108 can be positioned, and can include a stage positioning mechanism for selectively moving the stage in an xy-plane for viewing samples positioned thereon, as is known in the art. In some embodiments, the stage housing is the stage assembly. Accordingly, as used herein, the “stage housing” is intended to include a microscope sample stage for holding and/or positioning samples to be imaged. This term can also be used to describe additional features associated with the stage, including, for example, elements for controlling environmental conditions around the sample, such as any one or more of a heating element, cooling element, fan, gas sensor/inlet (e.g., oxygen, carbon dioxide, etc.), vacuum, compressor, or other element or physical housing associated with or coupled to the sample stage.

In the depicted embodiment, microscope assembly 104 houses an inverted microscope that can be used to perform screening of specimens on specimen sample plate 108b from underneath the sample. The microscope includes an objective assembly 118 comprising a plurality of objectives, as is known in the art, to obtain magnified views of the sample. In one embodiment, one or more standard objectives are included with one or more immersion objectives. Example standard objectives include 2×/0.08 NA, 4×/0.16 NA, 10×/0.4 NA, 20×/0.45 NA, 20×/0.7 NA, and 40x/0.6 NA objectives. Any one or more of the foregoing standard objectives can be included on a turret or lens slider with any one or more of the following immersion objectives: 40×/1.3 NA, 50×/0.95 NA, 60×/1.25 NA, 100×/1.25 NA, 100×/1.28 NA, 100×/1.3 NA, and 100×/1.4 NA objectives. It should be appreciated that any number or combination of objectives (including other magnification levels and objective types known in the art) can also be used within embodiments of the present disclosure according to operator preference and/or application.

The microscope also includes a focus drive mechanism 120 mechanically coupled to microscope objective assembly 118. Objective assembly 118 can be moved up and down with respect to stage assembly 114 via focus drive mechanism 120 so as to align and focus any of the objectives of microscope objective assembly 118 on the biological cells disposed within specimen sample plate 108b. Focus drive mechanism 120 can be an auto focus mechanism, although that is not required. Focus drive mechanism 120 can be configured with a stepper motor and screw/nut combination that reduces anti-backlash to provide a resolution of, e.g., down to 0.006-μm/microstep to support the microscope objectives configured in imaging system 102.

The stage assembly 114 additionally includes an immersion media applicator 122 associated with the stage 116 for applying immersion media to objectives in the objective assembly 118. As an example embodiment to illustrate the objective workings of imaging system 102, objective assembly 118 can be configured in a custom-made fashion to provide a number of positions that enable interrogation of cells organized within sample plate 108b. Focus drive mechanism 120 can rapidly and reliably switch between the objectives in an automated fashion. When on a turret, the objectives in such an arrangement can be positioned, but not necessarily, at 60-degrees apart, which can enable the primary objective to focus on sample plate 108b without the other objectives interfering with the stage, sample plate 108b, or other components within imaging system 102.

To change the objective, focus drive mechanism 120 can drop below stage assembly 114, rotate to the next objective position and then push the objective up to a proper focusing height. To provide enhanced system safety, a mechanical limit switch can be used to home the turret, while one or more optical switches can be used to confirm that the position of the objective has been properly switched. In addition, each optical position can be held in place with an accurately machined mechanical detent on the rotating turret.

When switching to an immersion objective requiring application of immersion media prior to imaging, the focus drive mechanism 120 can drop the objective below the stage, the stage assembly can position the applicator 122 over the objective lens and apply a predetermined volume of immersion media to the immersion objective, and the stage assembly can reposition the sample 108 relative to the objective assembly 118 at the viewing position prior to application of the immersion media. The focus drive mechanism 120 can then position the immersion objective at the proper focusing height for imaging.

The microscope assembly 104 also includes various known components for generating and/or recording images of the samples. These components can include, but are not limited to, an image sensor 124 (e.g., a monochrome CCD or CMOS camera or sensor), a light source 126 (e.g., a light engine comprising multiple LEDs), optical filters that filter the excitation and emission lights (e.g., a multi-position dichroic filter wheel 128 and a multi-position emission filter wheel 130), and light directing devices that direct light through the microscope assembly (e.g., tube lens 132 and fold mirror 134). One or more of the above components are typically controlled by the computing device 110 to allow for automated imaging.

The microscope assembly 104 allows for epi-illumination (or reflected) light microscopy as well as transillumination light microscopy. In epi-illumination, light (e.g., white light) generated by the light source 126 is projected through the optical assembly along light path 136 where it is focused on and illuminates the sample 108. The reflected light is received at the objective lens and returned to the image sensor 124 along the reflected light path 138. Alternatively, transmitted white light can be generated by a transmission light assembly 140 for brightfield imaging. Light generated by the transmission light assembly 140 is passed through the sample and received at the objective lens of the microscope assembly 104. The light travels through the assembly 104 along light path 138 until received at the image sensor 124.

Although the discussion herein is geared toward the use of an inverted microscope configuration, it is to be appreciated that an upright microscope configuration can alternatively be used to perform screening from above the sample.

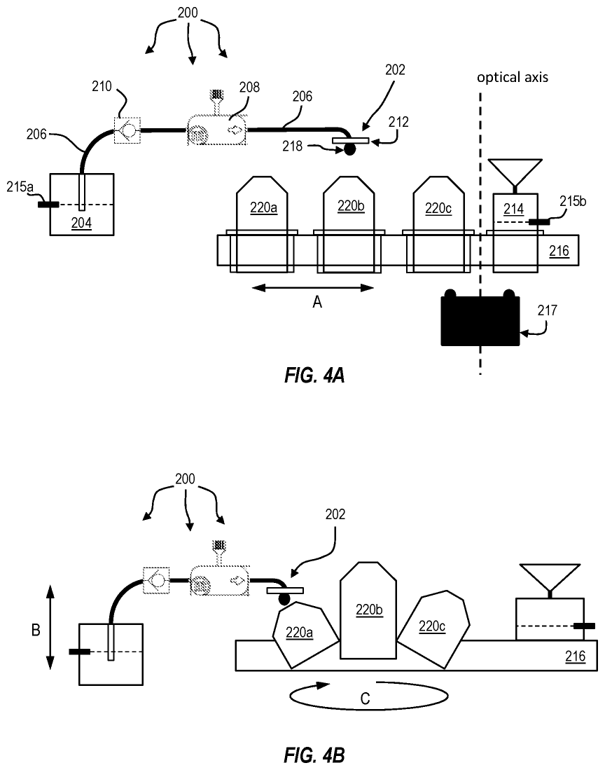

Immersion media applicators can be implemented in various ways. For example, FIGS. 4A and 4B illustrate an exemplary applicator assembly 200 that can be used to apply immersion media to objective lenses in an automated imaging system in accordance with embodiments of the present disclosure. The applicator assembly 200 can include nozzle 202 for dispensing immersion media fluidically coupled to a reservoir 204 of immersion media by a hose 206. The immersion media can be pumped from the reservoir 204 to the nozzle 202 by an inline pump 208 configured to deliver a predetermined, small volume of immersion media (e.g., 1-50 μL) with each cycle. It should be appreciated that the pump 208 can be calibrated and/or operable to handle the various types and viscosities of immersion media. In some embodiments, such as that shown in FIG. 4A, the applicator assembly 200 additionally includes a one-way, nonreturn valve 210 to prevent the pumped immersion media from retreating down the hose 206 and to the reservoir 204 between application periods. The valve 210 can additionally act to maintain pressure in the hose 206 and thereby maintain immersion media at the nozzle 202 between application periods and/or prevent bubble formation within the hose.

Accordingly, the applicator assembly 200 can be configured to dispense immersion media without bubbles. In some embodiments, the applicator assembly includes a sensor 212 at a distal end of the assembly 200. The sensor 212 can be a bubble sensor for detecting the presence of a bubble at the immersion media nozzle 202 or within the upstream hose 206 feeding immersion media to the nozzle 202. Additionally, or alternatively, the sensor 212 can be a liquid sensor for detecting the presence of immersion media at the nozzle 202. For example, the sensor 212 can be any of a capacitor sensor, an optical sensor, or multimeter that measures resistance at the dispensing tip of the nozzle 202. In operation, the sensor 212 can first register whether there is liquid at the nozzle 202. If present, the pump 208 can be activated for the predetermined number of cycles and/or period of time to deliver a known volume of immersion media (e.g., based on the pump type, diameter of the nozzle and hose, and type/viscosity of immersion media being dispensed). Alternatively, if the sensor 212 does not register liquid at the nozzle 202, the pump 208 can be activated until the sensor 212 indicates that liquid is present. As above, once the sensor 212 registers liquid at the nozzle 202, the pump 208 can be activated for the requisite time and/or number of cycles to dispense the desired volume of immersion media.

In some embodiments, pumping immersion media through the hose until the sensor registers liquid can be performed with the nozzle positioned over a waste reservoir 214, thereby preventing any immersion media from being accidentally discharged into the interior of the microscope assembly. Similarly, in embodiments where the applicator assembly includes a bubble sensor, the system can be operable to clear the line into a waste reservoir 214 to ensure a bubble-free line.

With continued reference to FIGS. 4A and 4B, the volume of immersion media within the reservoir 204 can be monitored, for example, by a level detector 215a operable to alert an associated computing system and/or user that the volume of immersion media within the reservoir 204 has reached or fallen below a predefined lower threshold. In some embodiments, if the level detector 215a indicates the volume of immersion media within the reservoir 204 has reached or fallen below the predefined lower threshold, the system may stop any current and/or additional automated imaging until such time that the immersion media reservoir 204 is replenished above the predetermined lower threshold (e.g., as confirmed by the level detector 215a).

Similarly, the waste reservoir 214 can be associated with a level detector 215b operable to monitor and/or identify when a volume of waste within the waste reservoir 214 has met or exceeded a predetermined upper threshold. The level detector 215b can alert the user and/or associated computing system that the waste reservoir is “full” and requires voiding of the liquid contents, and in some embodiments, the applicator may be prevented from dispensing immersion media into the waste reservoir until the level detector 215b indicates that the volume of immersion media within the waste reservoir 214 has fallen below the upper threshold. This can beneficially prevent overflow of immersion media from the waste reservoir 214, which can beneficially protect components from potentially damage from exposure to immersion media.

It should be appreciated that the applicator assembly can be provided with software or other set of computer executable instructions for configuring a computing system to operate and/or communicate with the liquid sensor, level detector(s), nozzle, valve, and/or pump. In this way, the applicator assembly can be incorporated with an automated imaging system and thereby allow proper application of immersion media to the desired objective lenses. In some embodiments, the applicator assembly can, itself, include the requisite operability for communicating with and between the discrete components of the assembly to enable any and/or all of the functions and operations of the assembly (or any of its individual components), as disclosed herein.

In some embodiments, the applicator assembly is stationary within the associated automated imaging assembly. For example, the nozzle 202 of the applicator assembly 200 can be positioned along the path of an objective slider 216 (e.g., as shown by arrow A in FIG. 4A) such that a volume of immersion media 218 can be applied to any of objectives 220a, 220b, 220c by selectively positioning the desired objective under the nozzle 202. In some embodiments, an associated focus drive mechanism (217) can control the z-direction of the objective slider 216 (e.g., as shown by arrow B in FIG. 4B) or individual objectives held by the objective slider 216 to ensure the desired objective is beneath the nozzle 202 when moving thereto or therefrom and/or to raise the objective to the nozzle for acquiring the immersion media.

With continued reference to FIG. 4B, the objective slider 216 can additionally include objectives 220a, 220b, 220c positioned on a turret such that they rotate (e.g., as indicated by arrow C). In such an embodiment, the slider 216 can be positioned laterally and vertically to receive a measure of immersion media from the nozzle 202 and can rotate objectives to the nozzle such that the objective receiving the immersion media is positioned closest to the nozzle compared to the other objectives on the turret.

While having a fixed nozzle location can beneficially reduce the risk of binding or breaking a tractable hose, the relocation precision of a moved objective lens is often worse than the relocation precision of a moved sample stage, causing an unintended shift in the image field of view. Accordingly, in some embodiments, the nozzle and hose can be incorporated into the sample stage itself.

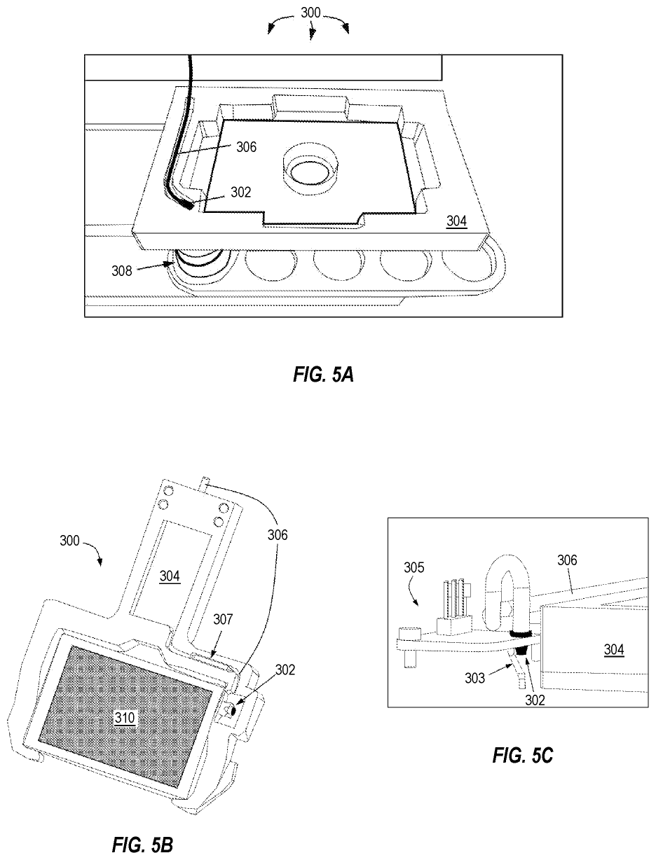

For example, as shown in FIGS. 5A-5C, an applicator assembly 300 can include a nozzle 302 integrated with the stage 304 such that the opening of the nozzle 302 is directed toward the back of the stage 304 in the direction of the objective lenses 308 (i.e., in an inverted microscope arrangement). The hose 306 can be situated within a channel created within the sample stage 304 and directed outside of the assembly where the immersion media reservoir is located (not shown). In this configuration, the hose 306 may have some additional slack to account for movement of the sample stage within the stage housing during sample reads and/or application of immersion media to the objective lenses.

As shown in FIG. 5A, for example, a channel is formed within the sample stage 304 and provides an unobtrusive, defined path for the hose 306. In this configuration, the hose is beneficially protected from entanglement or accidental disruption when a user places or removes a sample for imaging. The nozzle 302 is positioned on the sample stage 304 such that it can be accessed by the immersion lens 308 within the normal operational/movement parameters of the sample stage and/or lens slider (or analogous lens positioning apparatus). In some embodiments, the nozzle 302 is positioned such that it can interact with the lens surface of each immersion lens on an associated lens slider (or other lens positioning apparatus within the imaging system).

It should be appreciated that the position of the nozzle 302 in FIG. 5A can additionally include a space for a wipe or suction device operable to clean the lens surface of an immersion lens. As described above, the wipe or suction device is preferably positioned on the sample stage such that it can access the lens surface of each immersion lens on an associated lens slider (or analogous lens positioning apparatus, such as a lens turret) using the normal operating/movement parameters of the imaging system. In some embodiments, a second channel is formed in the stage and can be fitted with one or more hoses for adding or removing immersion objective wash solutions.

FIG. 5B illustrates another embodiment of an applicator assembly 300 having a hose 306 integrated within the sample stage 304. The specialized sample stage can be configured to retrofit an existing imaging system or can be incorporated during the original manufacturing process. As shown, the hose is connected to the applicator (e.g., nozzle 302) for dispensing immersion media to an immersion objective. The modified sample stage 304 of FIG. 5B can be configured to dispense immersion media onto an objective positioned below the stage (e.g., by projecting the nozzle through an aperture formed in the bottom surface of the sample stage). Alternatively, the applicator can be oriented to dispense immersion media to an overhead immersion objective (e.g., positioning the nozzle in the direction of the opening of the channel formed in the sample stage).

As further illustrate by the embodiment of FIG. 5B, the applicator assemblies disclosed herein can include a wider diameter portion 307 of the hose 306 upstream of the applicator (e.g., nozzle 302) to prevent or reduce bubble formation while dispensing immersion media. The wider diameter portion 307 beneficially allows for any air within the hose to be trapped therein and not progress through the hose to the nozzle where it is prone to cause bubbles or improper application of media. Further, in some embodiments, such as that shown in FIG. 5B, the wider diameter section can be positioned such that is easily viewable by a user or operator of the imaging system. The operator can therefore monitor the hose for trapped air or other contaminants and take appropriate action without compromising experimentation.

Referring specifically to FIG. 5C, components of an exemplary immersion media applicator system are illustrated in a close-up view. For ease of illustration, portions of the stage 304 into which the applicator is incorporated have been removed from view. It should be appreciated, however, that immersion media applicator systems disclosed herein can additionally be mounted onto a stage (similar to what is shown in FIG. 5C) instead of being bodily incorporated into the stage. Nevertheless, as shown in FIG. 5C, the exemplary immersion media applicator system can include a nozzle 302 oriented in the direction of the objective lens—in this case toward a bottom surface of the stage 304 such that the nozzle 302 can selectively engage objectives of an inverted microscope system. The immersion media applicator system can additionally include a sensor 303 for detecting the presence of immersion media at the nozzle 302. In the exemplary embodiment shown, the sensor 303 includes a test wire in electrical communication with a PCB 305 configured to measure the resistance between the nozzle and the test wire. Immersion media contacting both the (conductive) nozzle and the test wire reduces the resistance, indicating that immersion media is being dispensed from the nozzle. It should be appreciated that the sensor 303 illustrated in FIG. 5C is illustrative and other liquid sensors can be used and are within the scope of the present disclosure.

In some embodiments, the objective lenses can be positioned on a turret that can rotate various lenses into the optical light path of the microscope assembly. The objective lenses on the turret can be positioned in the correct focal plane by a focus drive mechanism but can be otherwise stationary with respect to lateral movements (e.g., in the x- and y-directions). In such embodiments, the sample stage can be responsible for positioning the applicator nozzle in the correct xy-coordinate for application of immersion media to the objective lens. It should be appreciated that by limiting the movement of the objective lenses, the relocation precision of the sample field of view can be maximized in comparison to relocation precision when moving the objective lens.

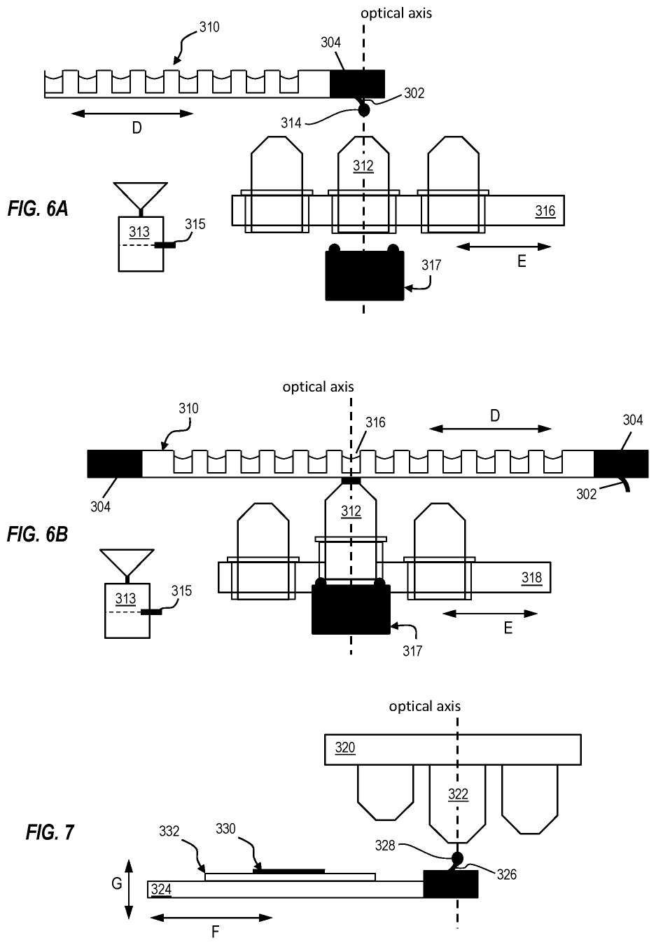

In some embodiments, one or both of the stage and objectives can translate in the xy-plane to orient the immersion media applicator in a position where immersion media can be dispensed appropriately onto a desired objective lens. For example, as shown in FIGS. 6A and 6B, a multiwell plate 310 having sample loaded therein is held by stage 304. The stage 304 includes an immersion media applicator formed therein with a nozzle 302 exposed on the bottom side thereof, directionally towards the objective lenses. In one embodiment, the stage 304 is moved (e.g., as shown by arrow D in FIG. 6A) to position the nozzle 302 over the desired immersion objective 312, as shown in FIG. 6A. A predetermined volume 314 of immersion media is dispensed from the nozzle 302 and applied to the immersion objective 312. The stage 304 can then be repositioned to the desired sample for imaging (e.g., as shown by arrow D in FIG. 6B), with the immersion media forming an immersion layer between the immersion objective 312 and the sample well 316.

Additionally, or alternatively, the objective lenses can be moved with respect to the sample stage to retrieve immersion media and return to the approximate field of view for imaging. For example, as shown in FIG. 6A, the objective lens slider 318 can be moved (e.g., as shown by arrow E) beneath the nozzle 302 of the immersion media applicator to receive the predetermined volume of immersion media on the desired immersion objective 312. The objective lens slider 318 can then be relocated to the sample well 316 (e.g., as shown by arrow E in FIG. 6B) to position the immersion objective 312 at the approximate field of view for high-resolution imaging. As shown in FIG. 6B, the aligned immersion objective 312 can be moved into position for viewing the sample 316 by a z-motor-driven objective mount 317. In some embodiments, both the stage and the objectives move relative to one another during immersion media application and/or repositioning of the objective lens and sample for imaging.

It should be appreciated that the foregoing movements of the stage and/or lenses can be implemented in an automated fashion and without physical interaction with the objectives by an operator. As such, embodiments of the present disclosure beneficially enable the automated application of immersion media to one or more objective lenses in an automated imaging system.

With continued reference to FIGS. 6A and 6B, the system can additionally include a waste reservoir 313 positioned (e.g., on the objective lens slider or in a stationary position within the imaging system) such that the immersion media applicator can dispense media or into the reservoir 313. The reservoir can be fitted with a funnel or similar to direct the dispensed media into the reservoir 313. In some embodiments, the applicator can dispense a cleaning solution for cleaning the immersion objectives and may additionally be outfitted with a wipe or suction device for removing dispensed cleaning solution from the lens surface. The waste reservoir 313 can be used to receive disposable wipes and/or can be connected to the suction device for receiving suctioned media/wash solution from the lens surface of the immersion objective and/or directly from the applicator/suction device. In some embodiments, the waste reservoir 313 can be associated with a fill sensor 315 for monitoring the level of waste in the reservoir 313 and can signal or otherwise indicate when the reservoir should be emptied.

It should be further appreciated that although FIGS. 4A, 4B, 6A, and 6B illustrate the objective lenses oriented as an inverted microscope, embodiments disclosed herein can additionally be configured for use with an upright microscope system where the objective lenses are oriented above the sample to be viewed.

One such exemplary system is illustrated in the schematic of FIG. 7. The system includes an objective mount 320 having an objective 322 disposed thereon. In some embodiments, such as that shown in FIG. 7, the objective mount 320 includes a plurality of objectives disposed thereon. The objective mount 320 can be stationary with respect to the stage housing 324, or in some embodiments, the objective mount 320 can move in one or more of an x, y, and/or z-direction relative to the stage housing 324. In some embodiments, the stage housing 324 moves laterally (e.g., in an xy-plane illustrated by at least arrow F) with respect to the objective mount 320 and can additionally move in a z-direction (e.g., in a z plane illustrated by at least arrow G) with respect to the objective mount 320. Accordingly, the stage housing 324 can move to selectively position an applicator nozzle 326 below a desired immersion objective (e.g., objective 322). The nozzle 326 can then dispense a desired volume of immersion media 328 onto the immersion objective using, for example, an inline micropump and/or liquid sensor such as that illustrated and discussed above with respect to FIGS. 4A and 4B or by any other embodiment disclosed and/or envisioned within the scope of the present description. The stage housing 324 can then be repositioned relative to the objective 322 such that the immersion media contacts an imaging surface and forms an immersion layer therebetween for immersion imaging of the sample. As shown in FIG. 7, the glass coverslip 330 covering a sample loaded onto microscope slide 332 can be a desired imaging surface for the illustrated upright objective configuration.

### Exemplary Automated Objective Lens Cleaning Systems

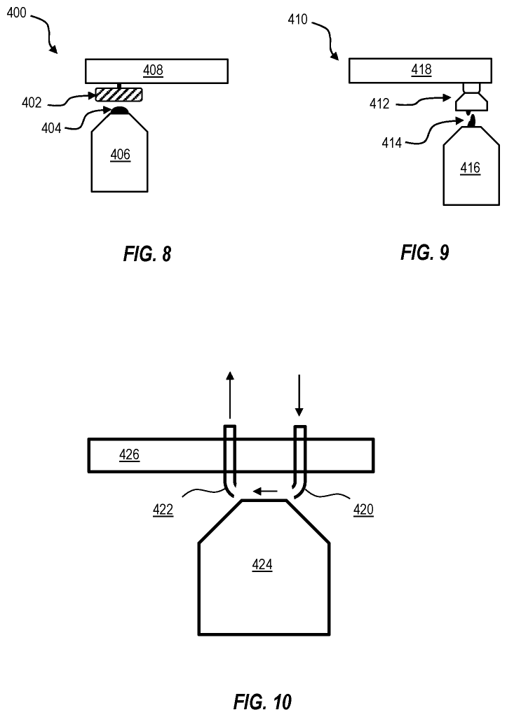

In addition to the foregoing, embodiments of the present disclosure additionally include systems for removing immersion media from objective lenses in an automated imaging system and/or for cleaning objective lenses in an automated imaging system. For example, FIG. 8 illustrates a schematic of an exemplary lens cleaning apparatus 400 that includes a wipe 402 configured to clean and/or remove immersion media 404 from the lens surface of the immersion objective 406. As shown, the wipe 402 is associated with the stage 408 and can be positioned relative to the objective lens as described above with respect to nozzle positioning in embodiments having an immersion media applicator. In some embodiments, the wipe can be dry lens paper for absorbing immersion media from the lens. In some embodiments, the wipe includes cleaning agent suitable for cleaning lens surfaces, as known in the art.

In some embodiments, the topology of the wipe is mapped and tracked by the computing system such that a clean or unused area of the wipe is used to clean each subsequent objective lens. During the cleaning process, the objective lens can be moved in a linear back and forth movement within a single plane or rotationally. In some embodiments, the wipe is associated with a translocation element, such as a solenoid, which provides vibration-like amplitude to the wipe movement. Such movement can be implemented, for example, by vibrating or moving the sample stage.

Additional cleaning systems are envisioned by the present disclosure. In addition to or alternatively from the wipe disclosed in FIG. 8, embodiments disclosed herein can include other exemplary lens cleaning apparatuses. For example, FIG. 9 illustrates a schematic 410 of a suction device 412 configured to remove immersion media 414 from the lens surface of an immersion objective 416. The suction device can be disposed at a stationary position within the housing of the imaging system or, as shown in FIG. 9, the suction device 412 can be mounted on a sample stage 418 and can be positioned relative to the objective lens as described above with respect to nozzle positioning in embodiments having an immersion media applicator.

In some embodiments, the applicator and cleaning system can be incorporated into a single and/or cooperative system. For example, FIG. 10 illustrates an exemplary dispensing and lens cleaning system that includes an immersion media dispensing nozzle 420 and a suction device 412. The dispensing nozzle 420 can be coupled to an immersion media reservoir and can be operable to dispense immersion media onto an immersion objective 424, as discussed herein. Additionally, or alternatively, the dispensing nozzle 420 can be coupled to a lens cleaning agent reservoir and can be operable to dispense cleaning agent onto the immersion objective 424. The suction device 422 can be positioned opposite the dispensing nozzle 420 (e.g., as shown in FIG. 10), although it should be appreciated that the suction device 422 can be positioned in other locations on the associated stage 426 relative to the dispensing nozzle 420. When positioned as illustrated in FIG. 10, immersion media and/or lens cleaning agent can be used to wash the immersion objective 424 by dispensing immersion media and/or lens cleaning agent from nozzle 420 while removing the dispensed media and/or cleaning agent traveling over the lens surface via the suction device 422. This can also advantageously allow bubbles to be removed from the immersion media hose without moving the nozzle 420 to a waste reservoir to clear the line. Instead, the line can be cleared at the immersion objective. Any bubbles within the line and dispensed onto the lens surface can be removed by the suction device 422 and/or additional flow of immersion media/cleaning agent over the lens surface that is subsequently removed from therefrom by the suction device 422.

It should be appreciated that in some embodiments, the nozzle 420 of FIG. 10 can be interchangeable or replaced with a wipe (e.g., similar to wipe 402 of FIG. 8). This can beneficially allow the cleaning system to first remove any immersion media from the lens surface via the suction device 422 followed by cleaning and/or buffing of the lens surface with the wipe, which can in some embodiments include cleaning agent. In this way, the wipe can be used a larger number of times or for a greater duration because it is being soiled with less immersion media (e.g., in instances where the immersion media is an immersion oil) and/or the cleaning agent is being diluted less by immersion media absorbed into the wipe (e.g., in instances where the immersion media is water).

### Abbreviated List of Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

It should be appreciated that the term “immersion media” includes any natural or synthetic media with a high refractive index (e.g., greater than 1.3, preferably greater than 1.5) that is suitable to increase the resolving power (i.e., the numerical aperture) of high-resolution objective lenses. The term “immersion media” is understood to include water or any transparent oil with the desired viscosity and optical characteristics for the given microscopic application.

As used herein, the term “immersion objective” is intended to include those objectives with a numerical aperture greater than 1 (i.e., the refractive index of air) and which benefit from or require the use of immersion media for optimal performance An “immersion objective” is understood to be synonymous herein with a “high-resolution objective lens” or other objective lens in the disclosed imaging systems that automatedly receives immersion media.

The term “stage housing,” as used herein, includes a stage and/or stage assembly mounted in a manner to optically and mechanically cooperate with components that make up a microscope assembly. A “stage assembly” can be the stage on which sample can be positioned and can additionally include a stage positioning mechanism for selectively moving the stage in an xy-plane for viewing samples positioned thereon, as is known in the art. As used herein, the term “stage housing” can also be used to describe additional features associated with the stage or stage assembly, including, for example, elements for controlling environmental conditions around the stage and/or mounted sample, such as any one or more of a heating element, cooling element, fan, gas sensor/inlet (e.g., oxygen, carbon dioxide, etc.), vacuum, compressor, or other element or physical housing associated with or coupled to the sample stage.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

As used herein, directional terms, such as “top,” “bottom,” “left,” “right,” “up,” “down,” “upper,” “lower,” “proximal,” “distal,” “adjacent,” and the like are used herein solely to indicate relative directions and are not otherwise intended to limit the scope of the disclosure and/or claimed invention.

### Conclusion

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed in part by preferred embodiments, exemplary embodiments, and optional features, modification and variation of the concepts herein disclosed may be resorted to by those skilled in the art, and such modifications and variations are considered to be within the scope of this invention as defined by the appended claims. The specific embodiments provided herein are examples of useful embodiments of the present invention and various alterations and/or modifications of the inventive features illustrated herein, and additional applications of the principles illustrated herein that would occur to one skilled in the relevant art and having possession of this disclosure, can be made to the illustrated embodiments without departing from the spirit and scope of the invention as defined by the claims and are to be considered within the scope of this disclosure.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

All references cited in this application are hereby incorporated in their entireties by reference to the extent that they are not inconsistent with the disclosure in this application. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques specifically described herein are intended to be encompassed by this invention.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure.

All changes which come within the meaning and range of equivalency of the claims are to be embraced within their scope.

1. An imaging system configured for automatic application and/or removal of immersion media, comprising:
a sample stage;
an imaging assembly disposed on a first side of the sample stage and comprising an immersion objective configured to selectively align with an optical axis of the imaging system; and
an applicator positioned to selectively interact with a lens surface of the immersion objective to deposit or remove immersion media.

2. The imaging system of claim 1, wherein the applicator comprises an immersion media nozzle configured to dispense immersion media without bubbles.

3. (canceled)

4. The imaging system of claim 2, further comprising a bubble sensor configured to detect a presence of a bubble at the immersion media nozzle or within an upstream line feeding immersion media to the immersion media nozzle.

5. The imaging system of claim 2, wherein the applicator comprises a liquid sensor for detecting a presence of immersion media at the immersion media nozzle, the liquid sensor comprising a resistance sensor or a capacitance sensor.

6. The imaging system of claim 5, wherein the liquid sensor comprises an optical sensor or a multimeter for measuring resistance at the nozzle.

7. (canceled)

8. The imaging system of claim 1, further comprising a hose joining the applicator to an immersion media reservoir and a pump associated with the hose and configured to dispense immersion media from the immersion media reservoir and through the applicator.

9. (canceled)

10. The imaging system of claim 8, wherein the pump is configured to dispense a desired volume of immersion media based on an operating time and/or a number of operating cycles.

11. The imaging system of claim 1, wherein the applicator is disposed on the first side of the sample stage.

12. The imaging system of claim 11, wherein the applicator is integrated into and co-translational with the sample stage.

13. The imaging system of claim 12, wherein the sample stage is a motorized xy-stage and configured to position the applicator adjacent to the lens surface of the immersion objective such that dispensing immersion media from the applicator causes immersion media to be deposited onto the lens surface of the immersion objective.

14. The imaging system of claim 1, wherein the imaging system comprises an inverted microscope with the imaging assembly being positioned below the sample stage and the first side of the sample stage being a bottom of the sample stage such that the applicator is disposed on the bottom of the sample stage directionally toward the immersion objective.

15. The imaging system of claim 1, wherein the imaging system comprises an upright microscope with the imaging assembly being positioned above the sample stage and the first side of the sample stage being a top of the sample stage such that the applicator is disposed on the top of the sample stage directionally toward the immersion objective.

16. The imaging system of claim 1, comprising a wipe configured to clean and/or remove immersion media from the lens surface of the immersion objective, the wipe containing a cleaning agent.

17-20. (canceled)

21. The imaging system of claim 16, further comprising a computing system configured to generate a map of the wipe, to track portions of the wipe previously used to clean the immersion objective, and to direct movement of the wipe on a subsequent cleaning operation to interact with the immersion objective at a clean or unused area of the wipe.

22. The imaging system of claim 1, wherein the applicator comprises a suction device configured to remove immersion media from the lens surface of the immersion objective.

23. The imaging system of claim 1, wherein the applicator is disposed at a stationary position within a housing of the imaging system.

24-31. (canceled)

32. A method for automatically applying immersion media to an immersion objective, comprising:
providing an imaging system that includes
a sample stage,
an imaging assembly disposed on a first side of the sample stage and comprising an immersion objective configured to selectively align with an optical axis of the imaging system, and
an applicator positioned to selectively interact with a lens surface of the immersion objective to deposit or remove immersion media;
positioning the sample stage relative to the immersion objective such that the applicator is adjacent to the lens surface of the immersion objective; and
dispensing immersion media from the applicator onto the lens surface of the immersion objective.

33-36. (canceled)

37. The method of claim 32, further comprising returning the sample stage to a viewing position after dispensing the immersion media from the applicator onto the lens surface.

38. The method of claim 37, further comprising positioning the sample stage relative to the immersion objective such that the applicator is adjacent to the lens surface of the immersion objective; and removing immersion media from the lens surface of the immersion objective via the applicator.

39. A kit for automatedly dispensing immersion media, comprising:
an immersion media reservoir configured to hold a volume of immersion media;
a nozzle fluidically coupled to the immersion media reservoir by an immersion media hose; and
a micropump operable to move immersion media from the immersion media reservoir, through the immersion media hose, and to the nozzle for dispensing.

40-45. (canceled)
